(19) United States
(12) Patent Application Publication
(10) Pub. No.: US 2010/0275714 A1
(43) Pub. Date: Nov. 4, 2010

(54) GEAR SHIFT CONTROL DEVICE FOR A VEHICLE GEARBOX WITH A ROTATING AND AXIALLY FLOATING DRUM

(75) Inventors: Kamal Mourad, Torino (IT); Guido Panizza, Torino (IT); Maurizio Bigi, Novi Di Modena (IT)

Correspondence Address: SUGHRUE MION, PLLC, 2100 PENNSYLVANIA AVENUE, N.W., SUITE 800, WASHINGTON, DC, 20037, US

(73) Assignee: AUTOMAC DI BIGI ING MAURIZIO S.A.S.

(21) Appl. No.: 12/812,158

(22) PCT Filed: Jan. 15, 2009
(86) PCT No.: PCT/IB09/50147

§ 371 Date: Jul. 8, 2010

(30) Foreign Application Priority Data
Jan. 16, 2008 (IT) TO2008A000035

(51) Int. Cl. F16H 63/18

(52) U.S. Cl. 74/473.11; 74/473.36

(57) ABSTRACT

The control device comprises an electric motor, a reduction gear, a shaft operable by the electric motor via the reduction gear, and a drum mounted on the shaft so as to be connected for rotation therewith but free to slide axially relative thereto. The drum has on its cylindrical lateral surface a guide groove in which a plurality of studs are guided, each of the studs being drivingly connected for translation with a respective shift finger in such a manner that the rotary motion of the drum is converted into the translational motion of the shift fingers to control the engagement of the gears according to predetermined modes of operation. The control device further comprises a locking device arranged to lock the translational motion of the drum during the synchronization and gear engagement phases and to unlock the translational motion of the drum upon completion of the engagement of the gear.

The present invention refers to a gear shift control device for a vehicle gearbox, in particular for a motor-vehicle gearbox, provided with a rotating and axially floating drum, as specified in the preamble of independent claim 1.

Modern mechanical gearboxes are generally of the type with permanently meshing gears, i.e. of the type in which the driving gearwheels carried by a primary shaft, or input shaft, permanently mesh with the respective driven gearwheels carried by one or more secondary shafts, or output shafts, and in which the driving gearwheels are rigidly connected for rotation with the primary shaft while the driven gearwheels are idly mounted on the secondary shaft or shafts. The engagement of a given gear is therefore brought about by coupling the idle gearwheel of the gear pair corresponding to the gear to be engaged for rotation with the respective shaft. To this end, to each idle gearwheel, or to each pair of adjacent idle gearwheels, there is associated a synchronizer having the function to synchronize, i.e. to equalize, the angular speeds of the idle gearwheel to be engaged and of the respective secondary shaft before completing the shift manoeuvre and starting therefore to transmit torque via the idle gearwheel in question.

A synchronizer typically comprises a driving part, which is rigidly connected for rotation by spline coupling with the respective shaft of the gearbox and which forms a conical mating surface intended to engage with a corresponding conical mating surface of the associated idle gearwheel, and a sleeve, which is rigidly coupled for rotation with the driving part, and hence with the respective shaft of the gearbox, and which is axially slidable in either direction by means of a respective shift fork. The sleeve of the synchronizer is provided, for each of the idle gearwheels associated thereto, with a toothing intended to mesh, as a result of the axial displacement of the sleeve, with a corresponding toothing of the idle gearwheel so as to make it possible to transmit torque between the idle gearwheel and the synchronizer, and hence between the idle gearwheel and the respective shaft of the gearbox.

A gear shift operation therefore comprises a first synchronization step, during which the conical mating surface of the sleeve is brought into abutment against the corresponding conical mating surface of the idle gearwheel to be engaged, and a second meshing step, during which the toothing of the sleeve is caused to mesh with the corresponding toothing of the idle gearwheel to be engaged. A given axial travel of the sleeve of the synchronizer corresponds to each of these steps.

In the common manually-operated mechanical gearboxes, the shift of a gear is controlled by the driver by means of a manual control lever, which allows to bring about each time the axial displacement of the shift fork associated to the synchronizer of the idle gearwheel of the gear pair corresponding to the desired gear.

In order to allow the driver to operate a common mechanical gearbox in sequential mode, gear shift control devices are known which comprise a rotating drum arranged parallel to the shafts of the gearbox and having on its outer cylindrical surface one or more guide grooves in which a plurality of studs, rigidly connected for translation each with a respective shift fork of the gearbox, are guided. The rotation of the drum is operated by an actuator unit, generally an electric motor coupled with a reduction gear, based on the commands imparted by the driver. The shape of the guide grooves of the drum is designed in such a manner as to cause, as a result of the rotation of the drum, a selective displacement of the studs, and hence of the shift forks, according to predefined operative modes to bring about each time the engagement of a given gear.

A gear shift control device for a vehicle gearbox provided with a rotating drum is known from German Patent application DE 19543645. According to this known example, the drum is mounted so as to float axially on a drive shaft operated by an electric motor. A pair of springs are arranged at the opposite axial ends of the drum to exert, as a result of an axial displacement of the drum in either direction, an axial biasing force tending to bring the drum back in a reference position, or neutral position. The use of an axially floating drum makes it possible to take up, by virtue of the axial displacement of the drum, the manufacturing tolerances of the gearbox. With the use in fact of an axially floating drum, should the shift fork arrive at the end-of-travel, i.e. should the gear shift operation be completed, before the drum has reached the predetermined angular position corresponding to the engagement of the gear in question, a further rotation of the drum causes an axial displacement of the drum in the opposite direction to the shift direction, instead of causing the drum to push the fork in the shift direction.

In a gear shift control device such as the one proposed in the above-mentioned prior art document, the preload of the springs must be high to exert a sufficient reaction onto the shift forks during the synchronizing step in order to avoid the generation of oscillations of the forks with such a high amplitude as to cause the engagement of the gear before the synchronization. However, in case of a “short” gearbox, i.e. a gearbox having an engagement travel shorter than the nominal one, a very high preload of the springs may cause the drum to exert at the end of the shift operation a correspondingly high residual load on the shift forks, which inevitably reduces the lifetime of the gearbox. Moreover, a very high preload of the springs requires the use of an electric motor of correspondingly high power, which leads inevitably to problems of low space availability and high consumption and costs.

It is therefore an object of the present invention to provide a gear shift control device for a vehicle gearbox, in particular for a motor-vehicle gearbox, which holds the advantages deriving from the use of an axially floating drum but is not affected by the drawbacks of the prior art indicated above.

This and other objects are fully achieved according to the invention by virtue of a gear shift control device for a vehicle gearbox, in particular for a motor-vehicle gearbox, having the features specified in the characterizing portion of independent claim 1.

In short, the invention is based on the idea of using a gear shift control device having a rotating and axially floating drum, in which the axial displacement of the drum is normally prevented by a locking device and is allowed only in a predetermined time interval during the gear shift operation.

According to a preferred embodiment of the control device, a locking groove is provided on the cylindrical lateral surface of the drum in addition to the guide groove in which the studs connected to the shift fingers of the gearbox engage and the locking device comprises a stop member movable between a locking position, in which it is engaged in the locking groove, thereby preventing any axial displacement of the drum, and an unlocking position, in which it is disengaged from the locking groove, thereby allowing axial displacements of the drum, a control mechanism being also provided to move the stop member between the aforesaid locking and unlocking positions.

The drum of the gear shift control device according to the invention can therefore be defined as a drum floating “on demand”. It is thus possible to keep the advantages of a floating drum, but to avoid at the same time the above-mentioned drawbacks, as will become clear in view of the following description.

In particular, the gear shift control device according to the invention is conceived to meet the following requirements:
the maximum engagement travel operable by the control device must comply with the maximum tolerances of the gearbox given by the manufacturer;
the drum must be able to float axially to take up the manufacturing tolerances of the gearbox;
the drum must be axially locked during the gear synchronization phase;
the drum must be axially locked at the beginning of the engagement phase, whereby it is possible to distinguish between the condition of correct engagement of the gear and the condition of crashing of the gears with the use of only one angular position sensor associated to the drum;
the drum must be free to float axially only upon completion of the engagement phase, i.e. only when the teeth of the idle gearwheel to be engaged and the teeth of the associated synchronizer mesh to such an extent as to ensure the transmission of the torque, and must be able to apply a load in the engagement direction high enough to synchronize and engage a gear (generally a load between 300 N and 500 N);
the drum must apply, at the end of the engagement travel, a residual load high enough to ensure that the gear remains engaged (typically a load in the order of 50 N); and
the control device must be able to absorb, when the drum is axially locked, the kinetic and inertial energy in excess of that which can be born by the synchronizers of the gearbox.

According to another aspect of the invention, the locking groove formed on the outer surface of the cylindrical skirt of the drum extends along a curved line suitably shaped to bring about, by virtue of the engagement with the stop member, an axial displacement of the drum resulting from the rotation of the drum itself about its own axis, which axial displacement overlaps with the axial displacement of the studs produced by the guide groove. A variable-throw cam system is thus obtained, wherein the guide groove in which the studs engage acts as a main cam arranged to produce a given axial displacement of the studs, while the locking groove in which the stop member engages acts as an auxiliary cam arranged to produce an axial displacement of the drum, and hence of the studs, which overlaps with the displacement produced by the main cam and which may be different from gear to gear so as to modulate the operation travel produced by the drum depending on the engagement travel actually required for each gear by the specific gearbox on which the control device is to be installed.

The main advantage offered by the use of an auxiliary cam is represented by the possibility to reduce the travel which has to be produced by the main cam and hence to reduce correspondingly the axial size of the drum.

Further features and advantages of the invention will appear from the following detailed description, given purely by way of non-limiting example with reference to the appended drawings, in which:

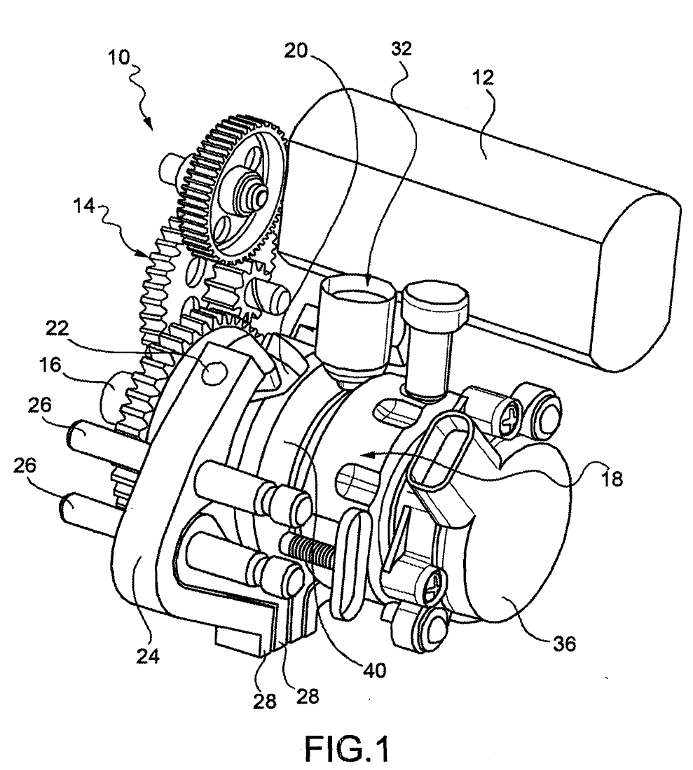

FIG. 1 is a perspective view of a gear shift control device for a motor-vehicle gearbox according to a preferred embodiment of the present invention;

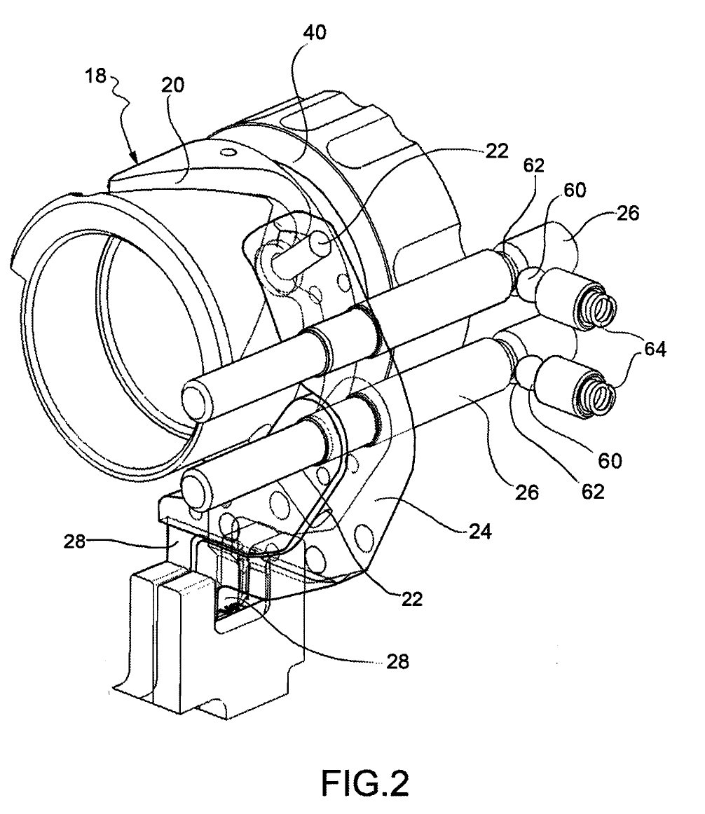

FIG. 2 shows a drum having a single guide groove and forming part of the control device of FIG. 1, along with a pair of shift fingers associated to the control device;

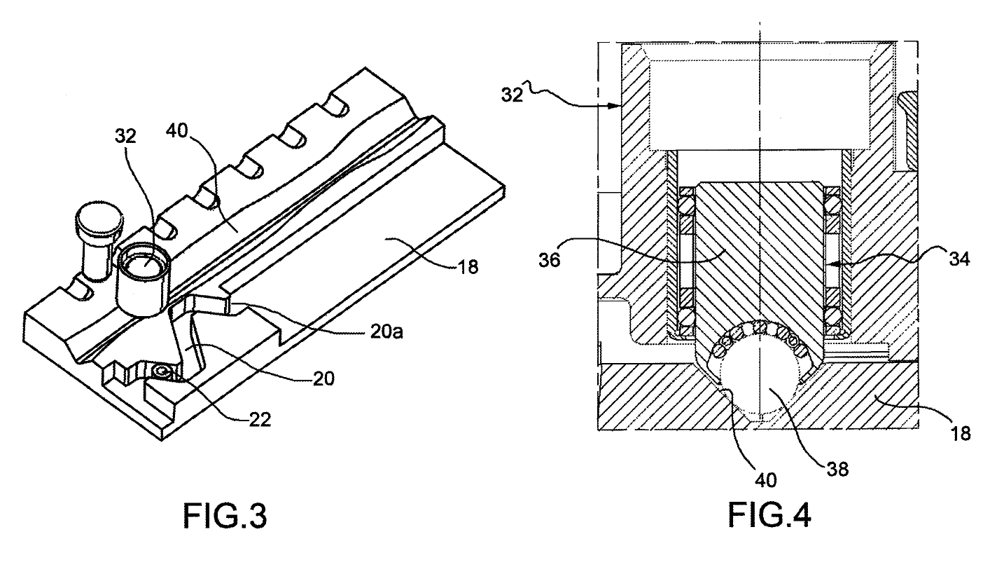

FIG. 3 shows the development of the cylindrical skirt of the drum of FIG. 2;

FIG. 4 is an enlarged section view of the axial locking device of the drum of FIG. 2;

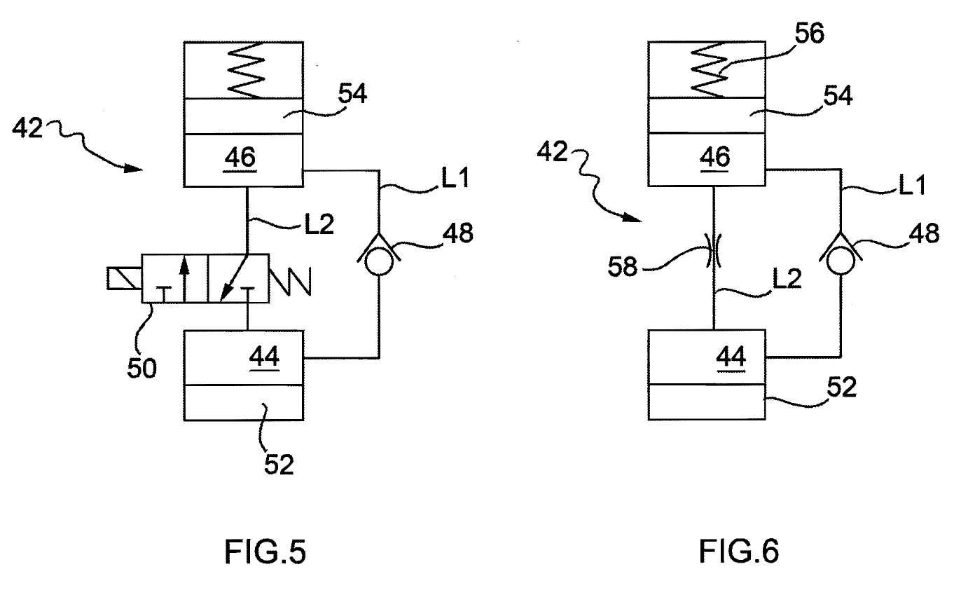

FIG. 5 is a schematic diagram of the control mechanism of the axial locking device of FIG. 4, according to a first, externally-operated version;

FIG. 6 is a schematic diagram of the control mechanism of the axial locking device of FIG. 4, according to a second, automatic version;

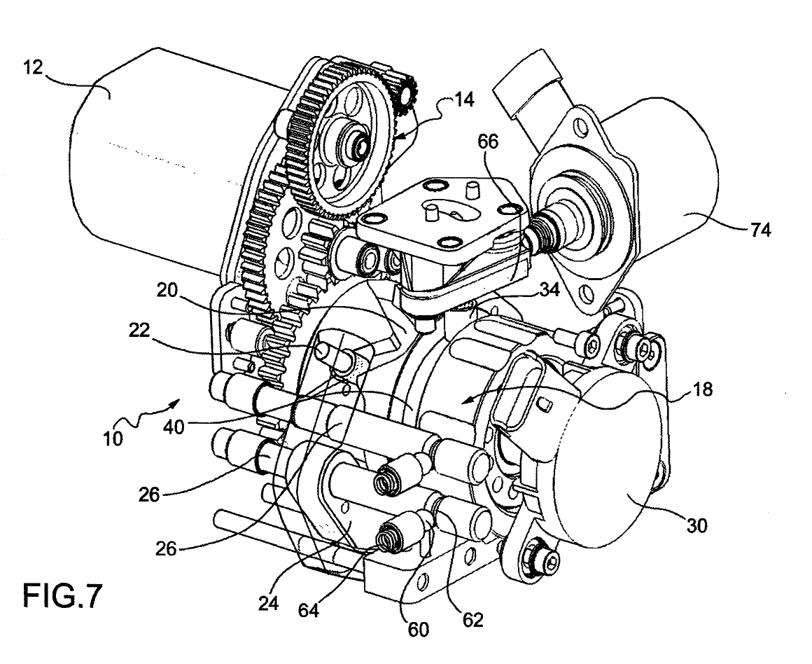

FIG. 7 is a perspective view of a gear shift control device for a motor-vehicle gearbox according to a further preferred embodiment of the present invention;

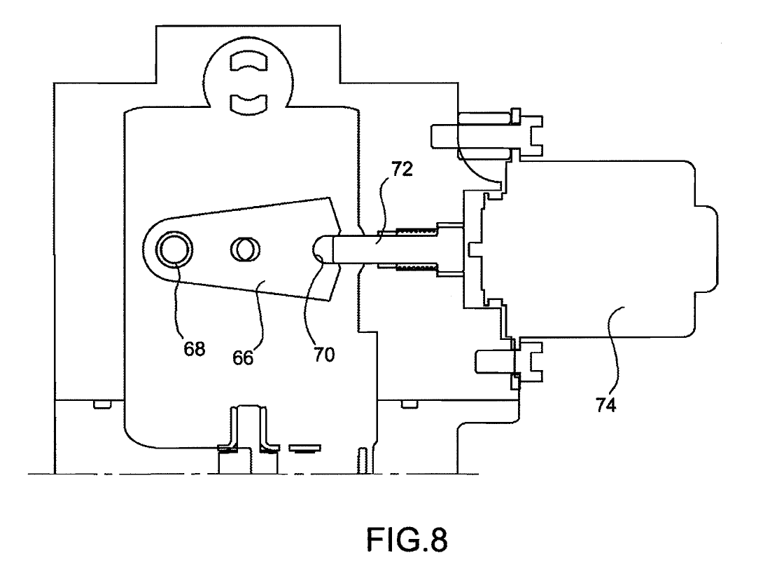

FIG. 8 is a schematic plan view of the control mechanism of the axial locking device forming part of the gear shift control device of FIG. 7;

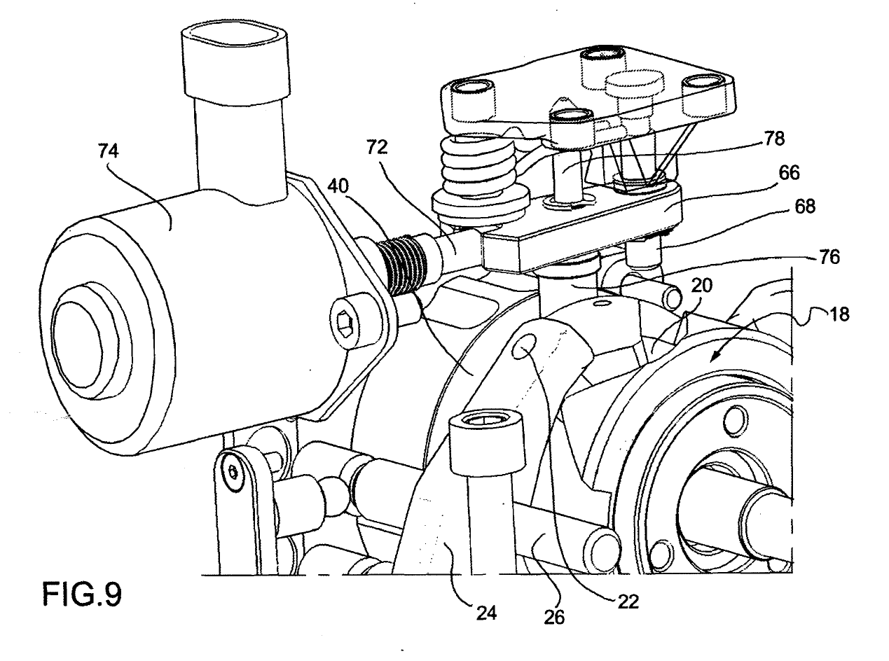

FIG. 9 is a perspective view showing in detail the control mechanism of FIG. 8;

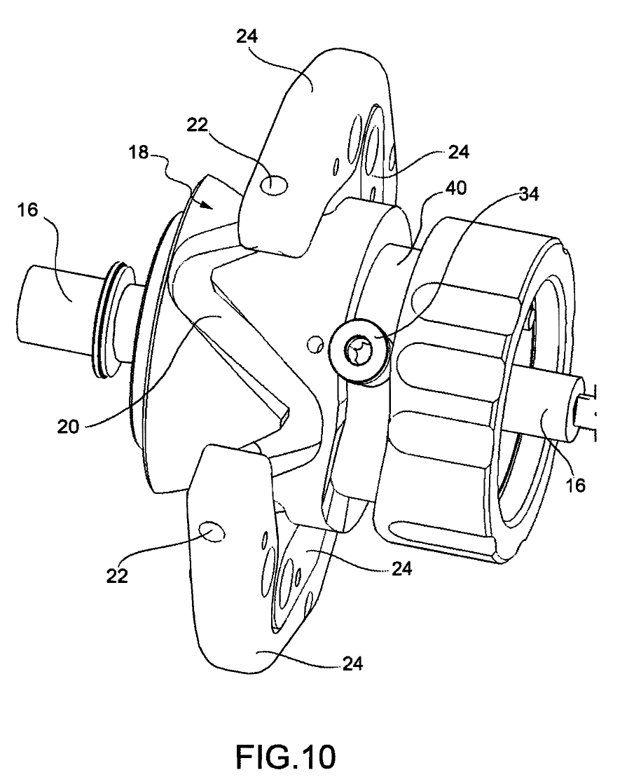

FIG. 10 is a perspective view of a variant of embodiment of the drum of the gear shift control device according to the present invention; and

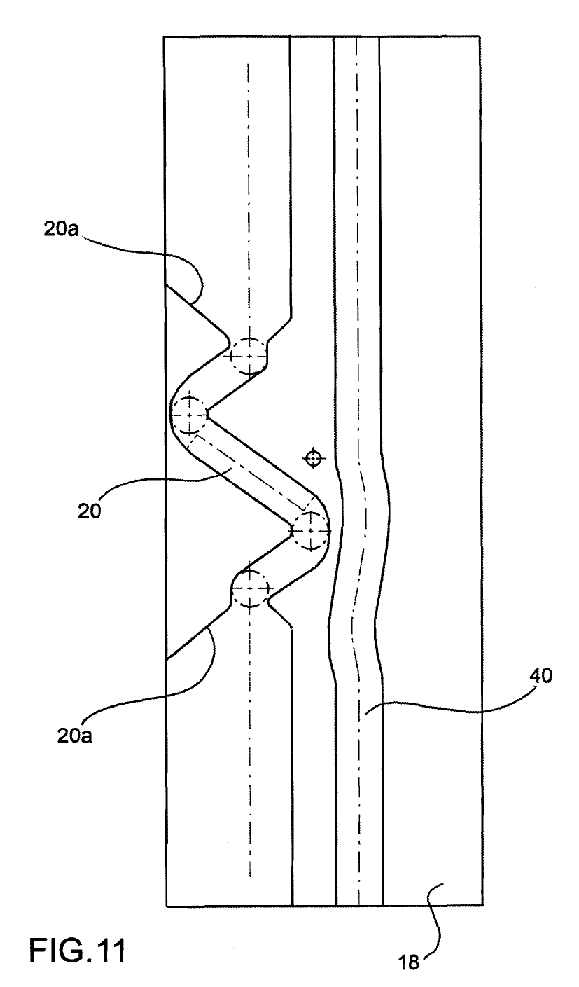

FIG. 11 shows the development of the cylindrical skirt of the drum according to the variant of embodiment of FIG. 10.

In the following description and claims, the terms axial and radial are to be intended as referred to the mounted condition of the gear shift control device on the gearbox, where the drum is arranged with its own axis of rotation parallel to the input and output shafts of the gearbox.

With reference first to FIG. 1, a gear shift control device for a motor-vehicle gearbox (not shown) according to a first preferred embodiment of the present invention is generally indicated 10.

The control device 10 basically comprises:
an electric motor 12 or another equivalent actuator device;
a reduction gear 14;
a drive shaft 16 which can be caused to rotate by the electric motor 12 via the reduction gear 14; and
a rotating drum 18 connected for rotation with the drive shaft 16 but axially slidable relative to this latter.

On the outer surface of the cylindrical skirt of the drum 18 a guide groove 20 is formed in which a plurality of studs 22, typically four studs (only one of which is shown in FIG. 1 and only two of which are shown in FIG. 2), are guided. Each stud 22 is drivingly connected for translation with a respective shift finger 24 which is secured to a respective slidable support rod 26 for actuation of a respective slidable engagement sleeve of the gearbox.

Although in the illustrated example the drum is provided with only one guide groove in which all the studs are guided, the invention is obviously to be intended as applicable to a control device comprising a drum provided with a plurality of guide grooves, for instance four guide grooves in each of which only one stud is guided.

As is known, the drum 18 has the function of converting the rotary motion imparted by the electric motor 12 to the drive shaft 16 via the reduction gear 14 into an axial translational motion of the studs 22, and hence of the shift fingers 24, so as to control the engagement of the gears according to predetermined modes of operation. To this end, the guide groove 20 is suitably shaped to cause each time, as a result of the rotation of the drum 18 by a given angle in either direction, the displacement of a first stud 22 to disengage the engaged gear and the displacement of a second stud 22 (which may coincide with the first one) to engage another gear.

The control device 10 is also provided (FIG. 1) with an angular position sensor 30 able to generate a signal indicative of the angular position of the drum 18 and to transmit this signal to an electronic control unit (not shown) of the gearbox for feedback control of the position of the drum.

As already mentioned above, the drum 18 is able to slide in the direction of its own axis, which coincides with the axis of the drive shaft 16. However, in order to lock the axial translational or floating movement of the drum 18 in a controlled way, the control device 10 is also provided with an axial locking device, generally indicated 32.

As illustrated in greater detail in FIGS. 4 to 6, in the embodiment of the control device of FIG. 1 the axial locking device 32 is electro-hydraulically operated and basically comprises:
a stop member 34 including a radial slider 36 which is able to translate in the direction of its own axis, i.e. in the radial direction relative to the drum 18, and carries at its end facing towards the drum 18 a ball 38 adapted to engage in a further groove 40 provided on the outer surface of the cylindrical skirt of the drum 18, hereinafter referred to as locking groove; and
a control mechanism, generally indicated 42 in FIGS. 5 and 6, arranged to normally urge the slider 36 against the drum 18 with a given force, whereby the ball 38 engages in the locking groove 40, preferably formed as a V-shaped groove, and therefore prevents the drum 18 from moving axially, and to leave on the other hand the slider 36 free to move away from the drum 18, whereby this latter can translate or float axially, in a predetermined time interval during a gear shift operation.

According to a first version illustrated in FIG. 5, the control mechanism 42 is operated externally, in particular by the above-mentioned electronic control unit of the gearbox. More specifically, the control mechanism 42 comprises a first pressure chamber 44 and a second pressure chamber 46 connected to each other through a first line L1, along which there is arranged a check valve 48 allowing a working fluid to flow only in the direction from the second chamber 46 to the first chamber 44, and through a second line L2, along which there is arranged a two-way two-position solenoid valve 50 which in the normal condition (solenoid not energized) closes the line L2. A first piston 52 arranged to act on the stop member 34, in particular on the slider 36, of the locking device 32 is slidable in the first chamber 44, while a second piston 54 biased by a spring 56 is slidable in the second chamber 46. The solenoid valve 50 is controlled by the electronic control unit of the gearbox.

In the not-energized condition of the solenoid valve 50 (line L2 closed), the spring 56 exerts onto the second piston 54 an elastic force of predetermined value and therefore generates in the working fluid received in the second chamber 46 a given pressure which is transmitted through the line L1 to the first chamber 44 and finally produces a given force onto the first piston 52 and hence onto the stop member 34. The stop member 34 is thus held in the locking position, in which the ball 38 engages in the locking groove 40 of the drum 18. The locking force of the drum 18, i.e. the force exerted onto the slider 36 of the stop member 34, depends of course on the preload of the spring 56 and on the cross-section areas of the two pistons 52 and 54, that is to say, of the two pressure chambers 44 and 46.

This condition is kept by the electronic control unit of the gearbox during a gear shift operation throughout the synchronizing phase and until the gear is engaged.

Once the gear is engaged, the drum 18 must be left free to float axially to take up the additional shift travels due to the manufacturing tolerances of the gearbox. To this end, the electronic control unit of the gearbox energizes the solenoid valve 50 so as to put the two pressure chambers 44 and 46 of the axial locking device 32 into communication with each other also through the second line L2. In this new condition, the stop member 34 is free to move upwards, thereby disengaging from the locking groove 40 and allowing the drum 18 to float axially. The upward displacement of the stop member 34 causes in fact the upward displacement of the first piston 52, the flow of the fluid from the first chamber 44 to the second chamber 46 through the second line L2 and hence the upward displacement of the second piston 54 against the elastic force of the spring 56.

Upon completion of the axial translation of the drum 18, the solenoid valve 50 is de-energized to allow the drum to get back into the normal working position in view of the following gear disengagement operation. In this way, in fact, the spring 56 urges the second piston 54 back into the initial position thereof within the second chamber 46 and, by virtue of the flow of the fluid from the second chamber 46 to the first chamber 44 through the first line L1, brings the first piston 52 back into the initial position thereof within the first chamber 44 and hence the stop member 34 into the engagement position in the locking groove 40. Once the normal working position has been reached, wherein the ball 38 of the stop member 34 is located in the lowest point of the V-shaped cross-section of the locking groove 40 (FIG. 4), the control device 10 is again in a condition suitable for the engagement of the next gear.

In order for the control mechanism 42 for axially locking/unlocking of the drum 18 to operate correctly, it is necessary to carry out a self-learning procedure when the control device 10 is installed onto the gearbox. The self-learning procedure also serves to take up the tolerances of the angular position sensor 30 and of the relative electric interface.

The self-learning procedure basically includes the step of determining the minimum and maximum values of the angular position sensor 30 and the step of learning the positions of the various gears.

During the step of determining the minimum and maximum values of the angular position sensor 30, the electric motor 12 is suitably operated to bring the drum 18 to the end of travel in both the directions of rotation, so as to detect the values of the angular position sensor 30 corresponding to those end-of-travel positions. During this step, the drum 18 has to be free to float axially and to this end the control mechanism 42 is suitably operated, for instance by energizing the solenoid valve 50 in the case of an electro-hydraulic control mechanism described above. Once the maximum angles of rotation of the drum 18 in the two opposite directions of rotation are known, the angular positions corresponding to the maximum throw of the drum for each gear, in addition to the neutral position, can be calculated. Upon completion of this first step, the drum 18 is brought back into the neutral position to carry out the next gear learning step.

The gear learning step is carried out as follows. First of all, with the drum 18 axially locked (solenoid valve 50 de-energized), the electronic control unit of the gearbox operates the electric motor 12 of the control device 10 so as to engage a gear (first or rear). As the drum 18 is axially locked, the rotation of the drum stops when the shift finger corresponding to the gear to be engaged arrives at the end of travel. The angular position of the drum 18 thus reached represents the engaged-gear position at which that gear will certainly be engaged during the normal operation of the control device 10. It is preferable to repeat the step of determining the engaged-gear position several times for each gear and to calculate then the average among the various detected values. The same procedure is then followed for the learning of all the other gears.

As an alternative to an externally-operated control mechanism, the stop member 34 may be controlled by means of an automatic control mechanism, i.e. a mechanism which does not need any electric command from outside. This automatic control mechanism is generally indicated 42 in FIG. 6, where components identical or corresponding to those of FIG. 5 have been indicated with the same reference numerals.

With reference to FIG. 6, the control mechanism 42 comprises a first pressure chamber 44 and a second pressure chamber 46 connected to each other through a first line L1, along which a check valve 48 is arranged which allows the working fluid to flow only in the direction from the second chamber 46 to the first chamber 44, and through a second line L2, along which a flow restrictor 58 is arranged. A first piston 52 acting on the slider 36 of the stop member 34 is slidably arranged in the first chamber 44, while a second piston 54 elastically biased by a spring 56 is slidably arranged in the second chamber 46. The automatically-operated control mechanism 42 of FIG. 6 differs therefore from the externally-operated one illustrated in FIG. 5 substantially in that the flow restrictor 58 is provided instead of the solenoid valve 50.

The control mechanism 42 works on the base of the principle of operation of a hydraulic damper, or better in a way contrary to that of a hydraulic damper, by using the difference between the angular speed of the drum 18 during the synchronization and engagement phases and that after the engagement phase.

More specifically, just before the beginning of the synchronization and engagement phases, the drum 18, which must be axially locked, is normally caused to rotate at a predetermined, rather high angular speed. The counter-reaction of the flow restrictor 58 at the end of the synchronization and engagement phases, in which the rotational speed normally tends to become null, is chosen so as to prevent the drum 18 from translating axially. Upon completion of the engagement, the drum 18, which now must be left free to translate or float axially to allow to shift to another gear, can be caused to rotate at a lower angular speed, if the size of the flow restrictor allows that. By virtue of the flow restrictor 58 provided on the second connection line L2 between the two pressure chambers 44 and 46, the control mechanism 42 reacts stiffly to the high-speed operating condition of the drum 18 during the synchronization and engagement phases, thwarting the flow of the working fluid from the first chamber 44 to the second chamber 46 through the line L2 and thus keeping the first piston 52 urged against the slider 36 of the stop member 34 to ensure the axial locking of the drum 18. The stiffness of the drum 18 is obviously proportional to the amount of restriction imposed by the flow restrictor 58 on the second line L2 and to the speed of the drum itself.

Once the engaged-gear position has been reached, since the speed of the drum 18 decreases significantly and therefore the slider 36 of the stop member 34 tends to move away slowly from the bottom of the locking groove 40, the flow restrictor 58 thwarts weakly to the fluid flow from the first chamber 44 to the second chamber 46 and hence allows the displacement of the first piston 52 in a similar way to that described above with reference to FIG. 5, in the energized condition of the solenoid valve 50.

The drum 18 moves back to the normal working position by virtue of the check valve 48, which allows the working fluid contained in the second chamber 46 to flow through the first line L1 to the first chamber 44 urged by the second piston 54 under the action of the spring 56.

With respect to the externally-operated version, the automatically-operated version of the control mechanism 42 requires a longer shift time when a multiple up- or down-shift is carried out, but has the advantage of a lower cost as it does not require a solenoid valve.

The slider 36 provided with the ball 38 and the V-shaped locking groove 40 in which the ball 38 engages may also act as a stop device for keeping the drum 18 stationary in the engaged-gear position in spite of the vibrations and jolts to which the control device 10 is subject in use. Alternatively, an independent stop device may be provided, which comprises a spring-loaded slider for engaging a circumferential groove formed on the outer surface of the cylindrical skirt of the drum 18.

On the one hand the axial translation of the drum 18 is necessary for the correct operation of the gear shift control device 10 in order to take up the manufacturing tolerances of the gearbox, but on the other it may involve some problems in use. In particular, during its axial translational movement the drum may entrain also those studs, and hence those shift fingers, which should be kept instead in the neutral position. This may cause damages to the synchronizers of the gearbox.

In order to compensate for such a drawback, in the gear shift control device 10 according to the invention the guide groove 20 extends preferably not throughout the circumference of the drum, but only along a portion of circumference having the length required to control the engagement travel of a gear, whereby each time only one of the studs is guided in the guide groove while all the remaining studs remain free.

The guide groove 20 also has, at both its opposite ends, a lead-in portion 20a (FIG. 3) for making the insertion of the stud 22 each time intended to engage the guide groove 20 easier.

Moreover, in order to avoid undesired displacements of the shift fingers 24 connected to the studs 22 which are not engaged in the guide groove 20, and which are therefore in the neutral position, a spring-loaded reaction device (FIG. 2) is provided for each support rod 26 and comprises a ball 60 adapted to engage in a groove 62 of the support rod and a spring 64 which applies onto the ball 60 a resilient force tending to keep the ball in the groove 62.

A further preferred embodiment of a gear shift control device for a vehicle gearbox is illustrated in FIGS. 7 to 9, where parts and elements identical or corresponding to those of the first embodiment described with reference to FIGS. 1 to 6 have been given the same reference numerals.

This further embodiment of the gear shift control device differs from the first one substantially only in that in this case the axial locking device is electro-mechanically, instead of electro-hydraulically, operated. Therefore, only the axial locking device of this further embodiment will be described in detail, being it evident that what has been described and illustrated with reference to the first embodiment, as far as the structure and the operation of the drum are concerned, wholly applies to this further embodiment as well.

The axial locking device basically comprises a stop member 34 which permanently and slidably engages in a locking groove 40 provided on the outer surface of the cylindrical skirt of the drum 18, a rocking lever 66 which is articulated at an end thereof by means of an articulation pin 68 so as to be able to swing in a plane perpendicular to the axis of the stop member 34 (in other words, in a plane perpendicular to a radial direction of the drum 18) and which has a notch 70 at the opposite free end, a stud-shaped locking member 72 which has its own axis orientated perpendicularly to the swing axis of the lever 66 and is able to translate in the direction of its own axis between a locking position, in which it is engaged in the notch 70 thereby preventing the lever 66 from swinging about the pin 68, and a locking position, in which it is disengaged from the notch 70 thereby allowing the lever 66 to swing about the pin 68, and an actuator 74 arranged to cause the locking member 72 to move axially between the above-mentioned locking and unlocking positions under control of the electronic control unit of the gearbox. The stop member 34 includes a lower portion 76 engaging in the locking groove 40 and a pin-shaped upper portion 78 which extends coaxially of the lower portion 76, projects radially from the locking groove 40 and is articulated to the swing lever 66 at an intermediate point thereof between the end portion at which the lever is articulated to the pin 68 and the end portion in which the notch 70 is provided.

In the locking position, in which the stud 72 engages in the notch 70 of the lever 66, the swinging movement of the lever 66 about the pin 68, and hence also a possible movement of the stop member 34 in the direction of the axis of the drum, are prevented. Accordingly, the drum 18 is axially locked. On the other hand, in the unlocking position, in which the stud 72 is disengaged from the notch 70 and hence allows the lever 66 to swing about the pin 68, the stop member 34 does not restrain the drum 18 any more and therefore this latter is free to float axially. A spring 80 interposed between the lever 66 and a support bracket 82 on which the articulation pin 68 is mounted acts on the lever 66 so as to tend to bring this latter back into the condition of alignment of the notch 70 with the stud 72 when the lever is free to swing.

As illustrated in FIG. 10, in which parts and elements identical or corresponding to those of the preceding figures (in particular of FIG. 2) have been given the same reference numerals, according to another advantageous aspect of the invention the development of the locking groove 40 of the drum 18 is not wholly straight but at least partially curved with a suitable shape so as to cause, by virtue of the engagement with the stop member 34, an axial displacement of the drum 18, and hence of the studs 22 engaging in the guide groove 20, as a result of the rotation of the drum about its own axis. The axial displacement of the studs 22 results in this case from the sum of the axial displacements caused by the guide groove 20 and by the locking groove 40. A variable-throw cam system is thus obtained, in which the guide groove 20 acts as a main cam arranged to cause a given axial displacement of the studs 22, while the locking groove 40 acts as an auxiliary cam arranged to cause an additional axial displacement which may be different for each gear so as to modulate the control travel caused by the drum 18 depending on the engagement travel actually required for each gear by the specific gearbox on which the gear shift control device 10 is to be installed.

In particular, the main cam formed by the guide groove 20 is configured in such a manner as to produce a throw corresponding to the average of the shift travels required by all the gears of the gearbox on which the control device 10 is to be installed, while the auxiliary cam formed by the locking groove 40 is configured so as to produce a variable throw in order to take up for each gear the difference between the engagement travel actually required and the engagement travel defined by the throw of the main cam formed by the guide groove 20.

The main advantage of having the locking groove 40 extending along a curved path is the possibility to reduce the travel which has to be produced by the main cam formed by the locking groove 20, and to reduce therefore the axial size of the drum 18 correspondingly. With respect to an arrangement in which the locking groove 40 extends along a straight path, the axial floating travels of the drum 18 required to take up the differences between the engagement travels required and the engagement travels caused by the rotation of the drum are also reduced.

An example of shape of the guide and locking grooves 20 and 40 according to this variant embodiment of the drum 18 is illustrated in FIG. 11, which shows the development of the two grooves in plan view. As clearly results from FIG. 11, the locking groove 40 extends throughout the circumference of the drum 18 and includes a curved length at least partially overlapping with the guide groove 20.

Naturally, the principle of the invention remaining unchanged, the embodiments and constructional details may vary widely with respect to those described and illustrated purely by way of non-limiting example.

1. Gear shift control device for a vehicle gearbox, in particular for a motor-vehicle gearbox, comprising
a rotating drum able to translate or slide in the direction of its own axis, the drum having at least one first groove on its cylindrical lateral surface,
a plurality of studs guided in said at least one first groove,
a corresponding plurality of shift fingers drivingly connected each for translation with a respective stud, and
a locking device arranged to lock or unlock selectively the translational motion of the drum along its own axis,
wherein said at least one first groove extends at least partially along a curved path suitably shaped in such a manner that the rotary motion of the drum about its own axis is converted into a translational motion of the studs, and hence of the shift fingers, to bring about the engagement and the disengagement of the gears according to predetermined modes of operation.

2. Device according to claim 1, wherein the locking device is arranged to lock the axial translational motion of the drum during the synchronization and gear engagement phases and to unlock the axial translational motion of the drum upon completion of the engagement of the gear.

3. Device according to claim 1, wherein the drum has only one first groove.

4. Device according to claim 3, wherein the first groove extends along a portion of the circumference of the drum of such a length as to cause each time the engagement of a single gear, whereby each time only one of the studs is guided in the first groove, while all the remaining studs are instead disengaged from the first groove so as to prevent the shift fingers associated to the studs disengaged from the first groove from translating during the axial translational motion of the drum.

5. Device according to claim 4, wherein the first groove has at its opposite ends respective lead-in portions to make the insertion of the stud each time intended to engage the groove easier.

6. Device according to claim 1, wherein the drum has on its cylindrical lateral surface a second groove and wherein the locking device comprises a stop member able to engage in the second groove to lock the axial motion of the drum.

7. Device according to claim 6, wherein the stop member is movable between a locking position in which it is engaged in the second groove to lock the axial motion of the drum and an unlocking position in which it is disengaged from the second groove to allow the drum to move axially, and wherein the locking device further comprises a control mechanism arranged to move the stop member between the locking and unlocking positions.

8. Device according to claim 7, wherein the stop member comprises a slider movable in the radial direction of the drum between the locking and unlocking positions and a ball carried by the slider and arranged to engage in the second groove.

9. Device according to claim 7, wherein the control mechanism comprises
a first pressure chamber in which a first hydraulic piston operatively associated to the stop member is slidably received;
a second pressure chamber in which a second piston is slidably received;
a first line and a second line which connect the two pressure chambers to each other;
a check valve arranged along the first line to allow a working fluid to flow only in the direction from the second chamber to the first chamber;
resilient means for exerting a force on the second piston tending to cause the working fluid to flow from the second chamber to the first chamber along the first line (L1) to move the stop member into the locking position; and
flow control means arranged along the second line per control the flow of the working fluid from the first chamber to the second chamber so as to allow the stop member to move into the unlocking position.

10. Device according to claim 9, wherein said flow control means comprise a two-way two-position solenoid valve able to assume a first position in which it closes the second line to keep the stop member in the locking position and a second position in which it opens the second line to allow the stop member to move into the unlocking position.

11. Device according to claim 10, wherein the solenoid valve is arranged, in the not-energized condition, in said first position.

12. Device according to claim 9, wherein said flow control means comprise a flow restrictor arranged along the second line to allow the fluid to flow from the first chamber to the second chamber only when the drum rotates at an angular speed which is lower than a predetermined angular speed.

13. Device according to claim 6, wherein the stop member permanently engages in the second groove so as to be drivingly connected for axial translation with the drum and wherein the locking device further comprises a mechanism arranged to lock/unlock the axial motion of the stop member.

14. Device according to claim 13, wherein said mechanism comprises
a rocking lever articulated at an end thereof so as to be able to swing in a plane perpendicular to a radial direction of the drum substantially coinciding with an axis of the stop member, wherein the lever has at its opposite end a notch and engages a portion of the stop member radially projecting from the second groove;
a locking stud movable between a locking position, wherein it is engaged in the notch thereby preventing the lever from swinging and hence the stop member and the drum from translating axially, and an unlocking position, wherein it is disengaged from the notch thereby allowing the lever to swing and hence the stop member and the drum to translate axially, and
an actuator arranged to control the movement of the locking stud between the said locking and unlocking positions.

15. Device according to claim 14, wherein the locking stud is movable between the said locking and unlocking positions by translation in a direction perpendicular to the swing axis of the rocking lever.

16. Device according to claim 6, wherein the second groove has an at least partially curved development suitably shaped so as to produce, as a result of the engagement with the stop member, an additional axial displacement of the drum which overlaps with the axial displacement of the studs produced by the guide groove as a result of the rotation of the drum.

17. Device according to claim 16, wherein the second groove is shaped so as to produce an additional axial displacement different from gear to gear.

18. Device according to claim 1, further comprising an electric motor, a reduction gear and a drive shaft operable by the electric motor via the reduction gear, the drum being mounted on the drive shaft so as to be connected for rotation therewith but free to slide axially relative thereto.
